(19) United States
(12) Patent Application Publication
(10) Pub. No.: US 2025/0037934 A1
(43) Pub. Date: Jan. 30, 2025

(54) MULTILAYER CAPACITOR

(71) Applicant: TDK Corporation, Tokyo (JP)

(72) Inventors: Hikaru HIRABAYASHI, Tokyo (JP); Daisuke HIMETA, Tokyo (JP); Daisuke YOSHIDA, Tokyo (JP); Yuya NAGASAKI, Tokyo (JP)

(73) Assignee: TDK Corporation, Tokyo (JP)

(21) Appl. No.: 18/763,080

(22) Filed: Jul. 3, 2024

(30) Foreign Application Priority Data
Jul. 28, 2023 (JP) 2023-123004

(51) Int. Cl. H01G 4/012; H01G 4/008; H01G 4/30

(52) U.S. Cl. CPC H01G 4/012; H01G 4/0085; H01G 4/30

(57) ABSTRACT

In an element body of a multilayer capacitor C1, a plurality of dielectric layers and a plurality of internal electrode layers extend in a first and second direction orthogonal to each other, and the plurality of dielectric layers and the plurality of internal electrode layers are alternately laminated in a third direction intersecting the first direction and second direction. The element body includes at least one end surface. At least one internal electrode layer among the plurality of internal electrode layers is exposed from the plurality of dielectric layers at at least one end surface. The external electrode terminal is provided on the at least one end surface and is connected to the at least one internal electrode layer. In the element body, a weight ratio of a metal containing Ni is from 20% to 25%, and a weight ratio of sulfur is from 3 ppm to 20 ppm.

### BACKGROUND OF THE INVENTION

### 1. Field of the Invention

The present invention relates to a multilayer capacitor.

### 2. Description of Related Art

A multilayer capacitor including an element body and an external electrode terminal provided on the element body is known (for example, Japanese Unexamined Patent Publication No. 2003-218060 A). In the element body of the multilayer capacitor, a plurality of dielectric layers and a plurality of internal electrode layers are alternately laminated. The plurality of internal electrode layers are exposed from the plurality of dielectric layers at an end surface of the element body. The external electrode terminal is connected to at least one internal electrode layer.

### SUMMARY OF THE INVENTION

In the multilayer capacitor described above, the multilayer capacitor functions and electrical characteristics of the multilayer capacitor are secured by connection between the external electrode terminal and the internal electrode layer. Thus, it is required to improve connection reliability between the external electrode terminal and the internal electrode layer. When the plurality of internal electrode layers are configured to protrude from the plurality of dielectric layers at the end surface, it is considered that the connection reliability between the external electrode terminal and the internal electrode layer is improved.

The multilayer capacitor described above is also required to suppress occurrence of cracks in the element body. When the cracks occur, infiltration of moisture into the element body and disconnection and short circuit of the internal electrode may occur. Thus, for example, a chip component in which the cracks occur in the element body at a time of manufacturing is excluded. When the occurrence of the cracks is suppressed at the time of manufacturing, production throughput is improved.

An object of one aspect of the present invention is to provide a multilayer capacitor having a configuration in which occurrence of the cracks in the element body is suppressed, desired electrical characteristics are also secured, and connection reliability between the external electrode terminal and the internal electrode layer is improved.

The multilayer capacitor according to one aspect of the present invention includes the element body and the external electrode terminal. In the element body, the plurality of dielectric layers and the plurality of internal electrode layers extend in a first direction and a second direction orthogonal to each other, and the plurality of dielectric layers and the plurality of internal electrode layers are alternately laminated in a third direction intersecting the first direction and second direction. The element body includes at least one end surface. At least one internal electrode layer among the plurality of internal electrode layers is exposed from the plurality of dielectric layers at at least one end surface. The external electrode terminal is disposed on the at least one end surface. The external electrode terminal is connected to the at least one internal electrode layer. In the element body, a weight ratio of a metal containing Ni is from 20% to 25%, and a weight ratio of sulfur is from 3 ppm to 20 ppm.

As a result of intensive studies, the inventors of the present application have found that the occurrence of the cracks in the element body, the connection reliability between the external electrode terminal and the internal electrode layer, and the desired electrical characteristics depend on content ratios of the metal and sulfur in the element body. According to a research result of the inventor of the present application, when an amount of sulfur in the element body is too little, the plurality of internal electrode layers may not protrude from the plurality of dielectric layers at the end surface. When the amount of sulfur is too much in the element body, the cracks may occur in the element body. Also in a case where the amount of the metal is too much, the cracks may occur in the element body. When the amount of the metal is too little, it is difficult to secure capacitance per volume. On the other hand, according to further research by the inventors of the present application, when the content ratios of the metal and sulfur in the element body is within the above range, the occurrence of the cracks in the element body is suppressed, desired electrical characteristics are also secured, and the connection reliability between the external electrode terminal and the internal electrode layer is improved. Thus, manufacturing throughput can be improved.

In the above-described one aspect, when the end surface is viewed in plan view along a direction orthogonal to the end surface, a ratio of an area occupied by the plurality of internal electrode layers to an area of the end surface may be from 5% to 12%. In this case, a content ratio of sulfur contained in the internal electrode layer is easily balanced. Thus, the manufacturing throughput can be improved.

In the above-described one aspect, in each of the plurality of internal electrode layers, when the end surface is viewed in plan view along a direction orthogonal to the end surface, a value obtained by dividing an area of the internal electrode layer exposed from the plurality of dielectric layers by a volume of the internal electrode layer may be from 0.15 to 0.40. In this case, the content ratio of sulfur in the element body is easily balanced. Thus, the manufacturing throughput can be improved.

In the above-described one aspect, at least one end surface may include a pair of end surfaces. Lnternal electrode layers different from each other among the plurality of internal electrode layers are exposed at the pair of end surfaces, respectively. The plurality of internal electrode layers may include a pair of internal electrode layers. The pair of internal electrode layers are adjacent to each other. The pair of internal electrode layers are exposed at end surface different from each other among the pair of end surfaces. Each of the pair of internal electrodes may include an overlapping portion overlaps with the overlapping portion of the other internal electrode layer among the pair, and an extended portion connected to the overlapping portion of the same internal electrode layer, extending from the overlapping portion of the same internal electrode layer, and exposed at the end surface. When a width of the extended portion in the second direction is “W₁” and a width of the overlapping portion in the second direction is “W₂”, 1−(W₁/W₂) may be from 0.35 to 0.55. In this case, the content ratio of sulfur in the element body is easily reduced, and the thickness of the external electrode terminal is easily secured. Thus, the manufacturing throughput can be improved, and infiltration of a liquid into the internal electrode layer can be suppressed.

In the above-described one aspect, the plurality of dielectric layers may form a pair of outer layer portions located outside the plurality of internal electrode layers in the third direction and located so as to sandwich the plurality of internal electrode layers. The thickness of one of the pair of outer layer portions may be a length of 5% to 10% of the entire thickness of the element body in the third direction. In this case, the content ratio of sulfur in the element body is easily reduced, and the thickness of the external electrode terminal is easily secured. Thus, the manufacturing throughput can be improved, and infiltration of a liquid into the internal electrode layer can be suppressed.

The present invention will become more fully understood from the detailed description given hereinafter and the accompanying drawings which are given by way of illustration only, and thus are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a perspective view of a multilayer capacitor according to the present embodiment;

FIG. 2 is a partial cross-sectional view of the multilayer capacitor;

FIG. 3 is an end view of an element body in the multilayer capacitor;

FIG. 4 is a cross-sectional view of the element body as viewed along an extended direction of an extended portion;

FIG. 5 is a cross-sectional view of the element body as viewed along a lamination direction;

FIG. 6 is a graph for describing a set temperature in firing;

FIG. 7 is an enlarged view of the element body in the extended portion;

FIG. 8 is a graph showing a relationship between sulfur contents and protrusion lengths;

FIG. 9 is a view for describing a measurement of a protrusion amount;

FIG. 10 is a graph showing a relationship among the sulfur content, capacitance, and element thermal cracks; and

FIG. 11 is a table showing various Examples and Comparative Examples.

### DETAILED DESCRIPTION OF EMBODIMENTS

Hereinafter, embodiments of the present invention will be described in detail with reference to the accompanying drawings. In the description of the drawings, the same reference numerals are used for the same or equivalent elements, and redundant description will be omitted.

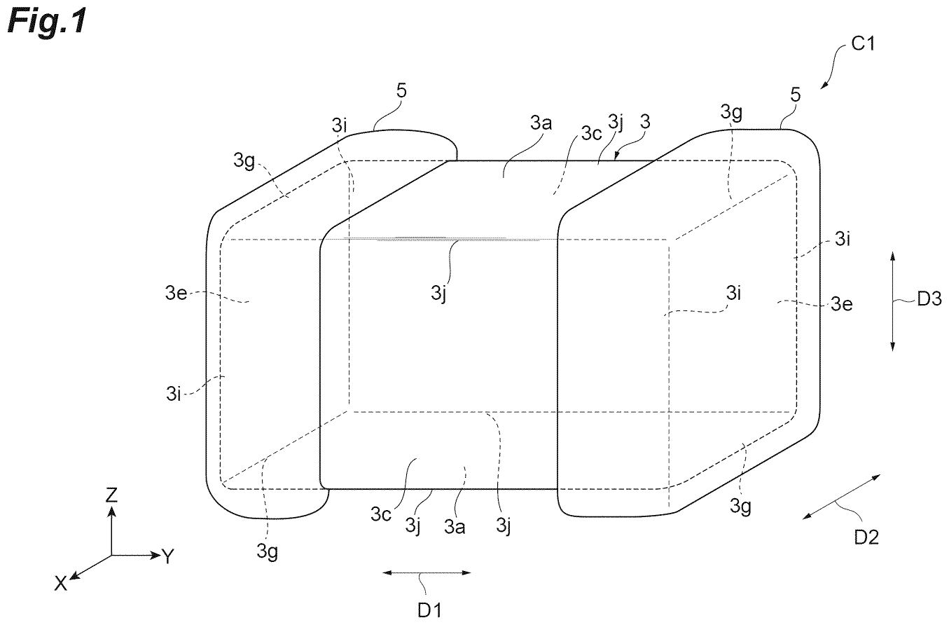

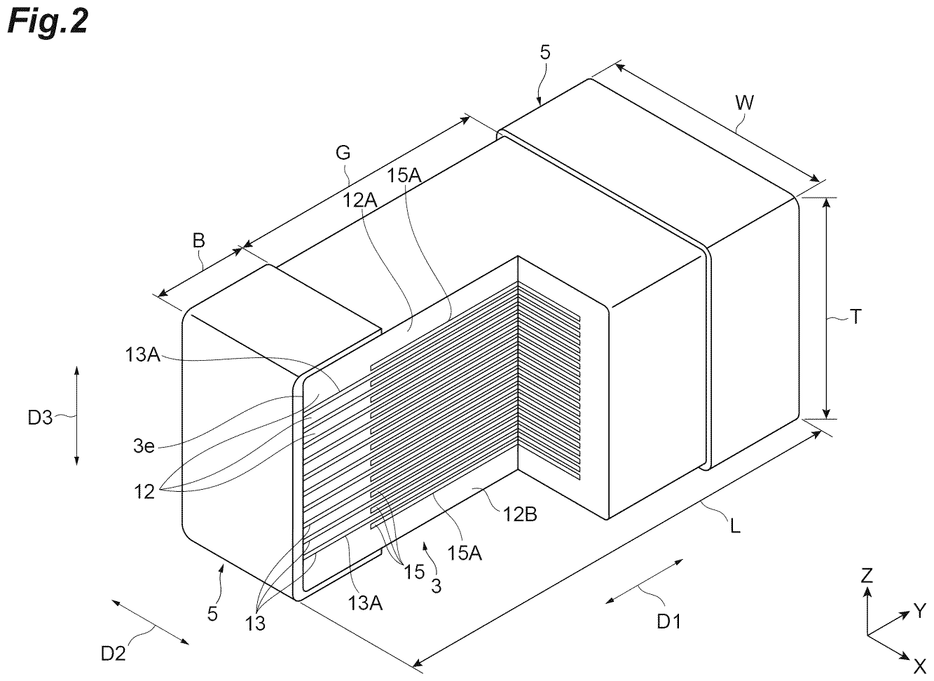

First, a configuration of a multilayer capacitor according to the present embodiment will be described with reference to FIGS. 1 to 7. A multilayer capacitor C1 is, for example, a multilayer ceramic capacitor. FIG. 1 is a perspective view of a multilayer capacitor according to the present embodiment. FIG. 2 is a partial cross-sectional view of the multilayer capacitor.

As illustrated in FIGS. 1 and 2, the multilayer capacitor C1 includes an element body 3 having a rectangular parallelepiped shape and a plurality of external electrode terminals 5. In the present embodiment, the multilayer capacitor C1 includes a pair of the external electrode terminals 5. The pair of external electrode terminals 5 are disposed on an outer surface of the element body 3. The pair of external electrode terminals 5 are separated from each other. The rectangular parallelepiped shape includes a rectangular parallelepiped shape in which corner portions and ridge portions are chamfered, and a rectangular parallelepiped shape in which the corner portions and the ridge portions are rounded.

The element body 3 includes a pair of side surfaces 3a facing each other, a pair of side surfaces 3c facing each other, and a pair of end surfaces 3e facing each other. The pair of side surfaces 3a, the pair of side surfaces 3c, and the pair of end surfaces 3e each have a rectangular shape. A direction in which the pair of side surfaces 3a face each other is a third direction D3. A direction in which the pair of side surfaces 3c face each other is a second direction D2. A direction in which the pair of end surfaces 3e face each other is a first direction D1. The first direction D1 and the second direction D2 are orthogonal to each other. The third direction D3 intersects the first direction D1 and the second direction D2.

The multilayer capacitor C1 is mounted to an electronic device by soldering. The electronic device includes, for example, a circuit board or a multilayer capacitor. In the multilayer capacitor C1, one side surface 3a faces the electronic device. The one side surface 3a is disposed so as to constitute a mounting surface. The one side surface 3a is the mounting surface. One side surface 3c of the pair of side surfaces 3c may also be disposed to constitute the mounting surface. For example, when the side surface 3a constitutes a first side surface, the side surface 3c constitutes a second side surface.

The third direction D3 is a direction orthogonal to each side surface 3a, and is orthogonal to the second direction D2. The first direction D1 is a direction parallel to each side surface 3a and each side surface 3c, and is orthogonal to the second direction D2 and the third direction D3. The second direction D2 is a direction orthogonal to each side surface 3c, and the first direction D1 is a direction orthogonal to each end surface 3e. In the present embodiment, the length of the element body 3 in the first direction D1 is larger than the length of the element body 3 in the second direction D2, and is larger than the length of the element body 3 in the third direction D3. The first direction D1 is a longitudinal direction of the element body 3. The length of the element body 3 in the second direction D2 and the length of the element body 3 in the third direction D3 may be equal to each other. The length of the element body 3 in the first direction D1 and the length of the element body 3 in the third direction D3 may be different from each other. In the example illustrated in the present embodiment, the first direction D1 corresponds to a Y-axis direction, the second direction D2 corresponds to an X-axis direction, and the third direction D3 corresponds to a Z-axis direction.

The length of the element body 3 in the third direction D3 is the height of the element body 3. The length of the element body 3 in the second direction D2 is the width of the element body 3. The length of the element body 3 in the first direction D1 is the length of the element body 3. In the present embodiment, a height T of the element body 3 is from 0.27 mm to 2.90 mm, a width W of the element body 3 is from 0.27 mm to 2.90 mm, and a length L of the element body 3 is from 0.57 mm to 3.60 mm. For example, the height T of the element body 3 is 1.84 mm, the width W of the element body 3 is 1.83 mm, and the length L of the element body 3 is 3.35 mm.

The pair of side surfaces 3c extends in the third direction D3 so as to connect the pair of side surfaces 3a to each other. The pair of side surfaces 3c also extends in the first direction D1. The pair of end surfaces 3e extends in the third direction D3 so as to connect the pair of side surfaces 3a to each other. The pair of end surfaces 3e also extends in the second direction D2.

The element body 3 includes four ridge portions 3g, four ridge portions 3i, and four ridge portions 3j. The ridge portion 3g is located between the end surface 3e and the side surface 3a. The ridge portion 3i is located between the end surface 3e and the side surface 3c. The ridge portion 3j is located between the side surface 3a and the side surface 3c. In the present embodiment, each of the ridge portions 3g, 3i, and 3j is rounded so as to be curved. The element body 3 is subjected to so-called round chamfering. The end surface 3e and the side surface 3a are indirectly adjacent to each other via the ridge portion 3g. The end surface 3e and the side surface 3c are indirectly adjacent to each other via the ridge portion 3i. The side surface 3a and the side surface 3c are indirectly adjacent to each other via the ridge portion 3j.

The element body 3 includes a plurality of dielectric layers 12, a plurality of internal electrode layers 13, and a plurality of internal electrode layers 15. In the element body 3, the plurality of dielectric layers 12, the plurality of internal electrode layers 13, and the plurality of internal electrode layers 15 are alternately laminated in the third direction D3. In other words, a lamination direction of the plurality of dielectric layers 12 and a lamination direction of the plurality of internal electrode layers 13 and 15 coincide with the third direction D3. The plurality of dielectric layers 12, the plurality of internal electrode layers 13, and the plurality of internal electrode layers 15 extend in the first direction D1 and the second direction D2.

Each dielectric layer 12 contains oxide ceramics. Each dielectric layer 12 is made of, for example, a sintered body of a ceramic green sheet containing a dielectric material. The dielectric material includes, for example, a dielectric ceramic such as BaTiO₃ based, Ba (Ti, Zr)O₃ based, or (Ba, Ca) TiO₃ based. In the actual element body 3, the dielectric layers are integrated to such an extent that a boundary between the dielectric layers cannot be visually recognized. Each of the internal electrode layers 13 and 15 is an internal conductor disposed in the element body 3. The plurality of internal electrode layers 13 and 15 face each other in the third direction D3. The plurality of internal electrode layers 13 are located closer to one of the pair of end surfaces 3e than the plurality of internal electrode layers 15. The plurality of internal electrode layers 15 are located closer to the other of the pair of end surfaces 3e than the plurality of internal electrode layers 13.

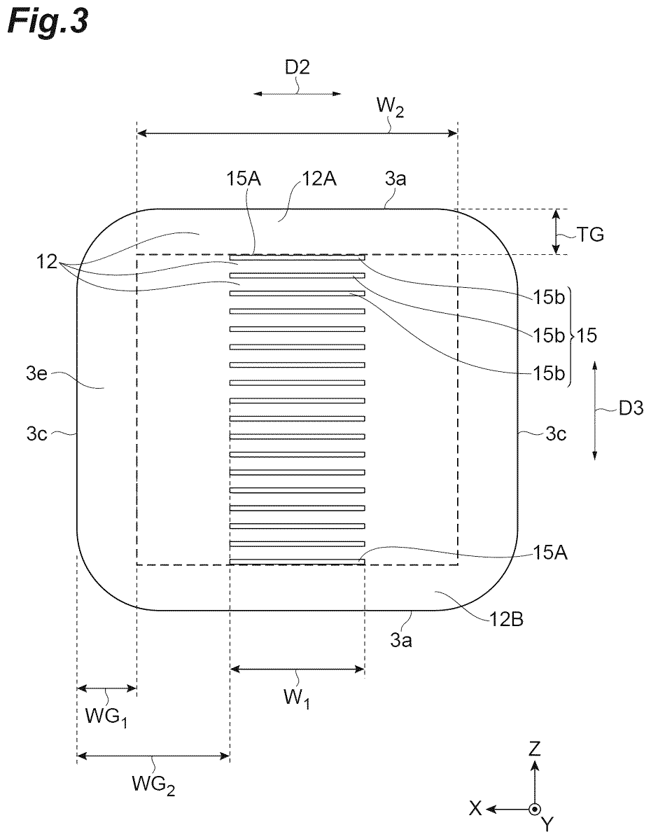

At least one end of the plurality of internal electrode layers 13 is exposed from a corresponding end surface 3e. At least one end of the plurality of internal electrode layers 15 is exposed from a corresponding end surface 3e. The plurality of internal electrode layers 13 and 15 include the one ends exposed from the corresponding end surfaces 3e, respectively. The plurality of internal electrode layers 13 and 15 are connected to the corresponding external electrode terminals 5 at portions exposed from the end surfaces 3e, respectively. FIGS. 2 and 3 illustrate, as an example, a state in which the plurality of internal electrode layers 15 are exposed from the end surface 3e. FIG. 3 is an end view of the element body 3 in the multilayer capacitor C1.

When the end surface 3e is viewed in plan view along the first direction D1 orthogonal to the end surface 3e, a ratio of an area occupied by the plurality of internal electrode layers 15 to an area of the end surface 3e is from 5% to 12%. Similarly, when the end surface 3e is viewed in plan view along the first direction D1 orthogonal to the end surface 3e, a ratio of an area occupied by the plurality of internal electrode layers 13 to the area of the end surface 3e is from 5% to 12%.

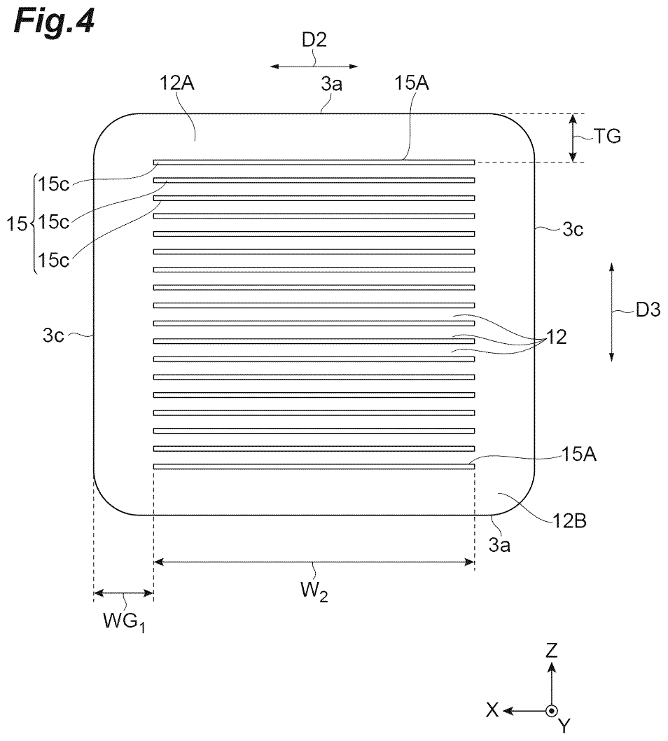

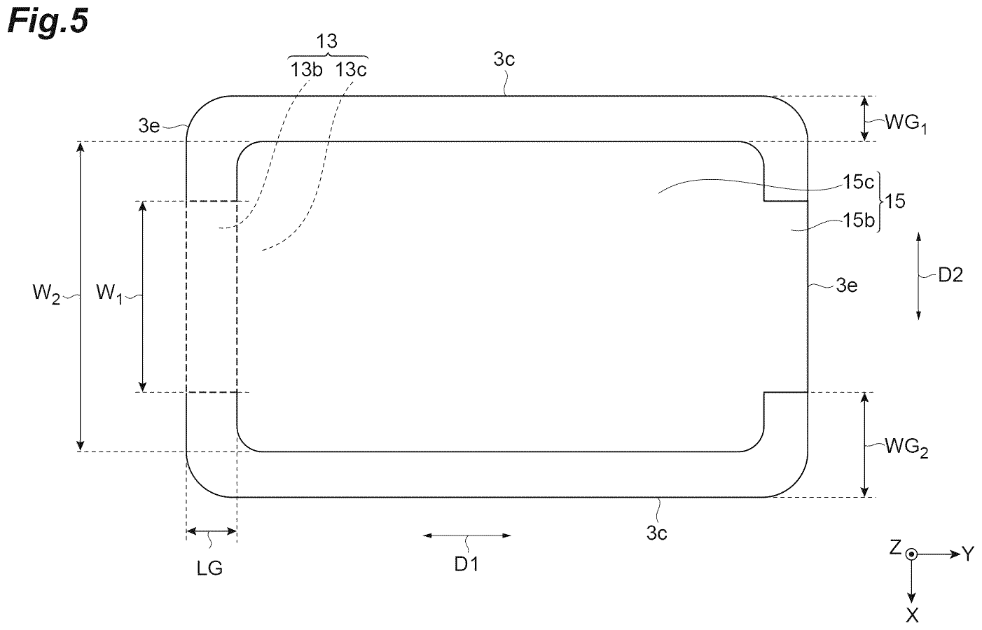

The plurality of internal electrode layers 13 and 15 include a pair of the internal electrode layers 13 and 15 adjacent to each other and exposed at different end surfaces 3e, respectively, of the pair of end surfaces 3e. As illustrated in FIGS. 3 to 5, each of the pair of internal electrode layers 13 and 15 includes an extended portion 15b and an overlapping portion 15c. FIG. 4 is a cross-sectional view of the element body 3 along the lamination direction as viewed along the first direction D1. FIG. 5 is a cross-sectional view of the element body 3 along the first direction D1 and the second direction D2 as viewed along the lamination direction.

The overlapping portion 15c is a portion of each of the pair of internal electrode layers 13 and 15 in which the pair of internal electrode layers 13 and 15 overlap each other. The extended portion 15b is a portion of each of the internal electrode layers 13 and 15 connected to the overlapping portion 15c. The extended portion 15b extends from the overlapping portion 15c in the first direction D1 and is exposed at the end surface 3e. When the width of the extended portion 15b in the second direction D2 is “W₁” and the width of the overlapping portion 15c in the second direction D2 is “W₂”, 1−(W₁/W₂) is from 0.35 to 0.55. 1−(W₁/W₂) can be expressed in percentage as a drawing ratio. When the above condition is satisfied, the drawing ratio is from 35% to 55%.

In each of the plurality of internal electrode layers 15, when the end surface 3e is viewed in plan view along a direction orthogonal to the end surface 3e, a value obtained by dividing an area of the internal electrode layer 15 exposed from the plurality of dielectric layers 12 by a volume of the internal electrode layer 15 is from 0.15 to 0.4. Similarly, in each of the plurality of internal electrode layers 13, when the end surface 3e is viewed in plan view along a direction orthogonal to the end surface 3e, a value obtained by dividing an area of the internal electrode layer 13 exposed from the plurality of dielectric layers 12 by a volume of the internal electrode layer 13 is from 0.15 to 0.4.

The area of each of the internal electrode layers 13 and 15 exposed from the plurality of dielectric layers 12 is calculated by, for example, the product of the width W₁ of the extended portion 15b in the second direction D2 and the thickness of the extended portion 15b in the third direction D3. The volume of each of the internal electrode layers 13 and 15 is the sum of the volume of the extended portion 15b and the volume of the overlapping portion 15c. The volume of the extended portion 15b is calculated by, for example, the product of the width W₁ of the extended portion 15b in the second direction D2, the width of the extended portion 15b in the first direction, and the thickness of the extended portion 15b. The volume of the overlapping portion 15c is calculated by, for example, the product of the width W₂ of the overlapping portion 15c in the second direction D2, the width of the overlapping portion 15c in the first direction D1, and the thickness of the overlapping portion 15c.

Each of the internal electrode layers 13 and 15 is made of a conductive material usually used as an internal conductor of a laminated electronic component. The conductive material contains, for example, a base metal. The conductive material contains, for example, Ni or Cu. The internal electrode layers 13 and 15 are configured as, for example, a sintered body of a conductive paste containing the conductive material. In the present embodiment, the internal electrode layers 13 and 15 are made of Ni. In the element body 3, a weight ratio of a metal containing Ni is from 20% to 25%. In the element body 3, a weight ratio of sulfur is from 3 ppm to 20 ppm.

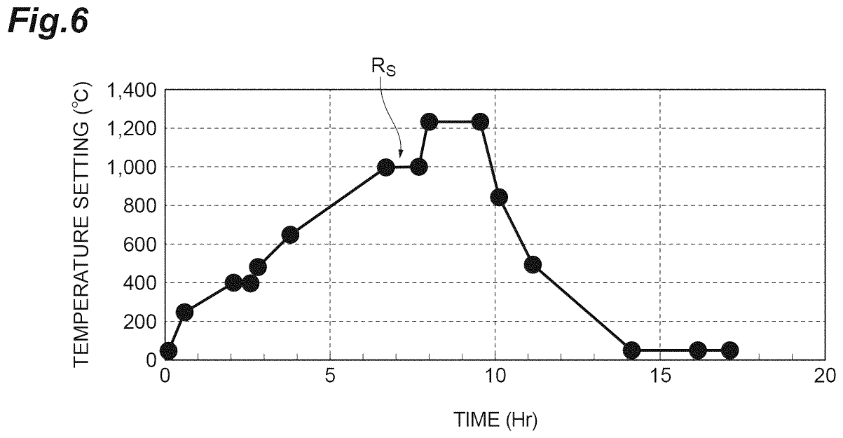

For example, the sulfur content in the element body 3 varies depending on a temperature setting of a debinding step performed before a firing step of the element body 3. In the debinding step, organic binders, organic solvents, and the like contained in the dielectric layer 12 and the internal electrode layers 13 and 15 before firing are removed from the element body 3. In the debinding step, the element body 3 placed on a setter is placed in a furnace, and heated in the furnace for 1 hour to 20 hours in a state where the set debinding temperature is kept constant. The setter includes, for example, a vent hole penetrating from a front side on which the element body 3 before firing is loaded to a back side. In the debinding step, the organic binders, the organic solvents, and the like in the element body 3 are gasified by vaporization, decomposition, or the like. FIG. 6 shows an example of a profile of temperature setting and time in the debinding step. In this case, a range Rs in which the temperature setting is maintained at 1000° C. in the debinding step is included.

The internal electrode layer 13 and the internal electrode layer 15 are disposed at different positions (layers), respectively, in the third direction D3. The internal electrode layers 13 and the internal electrode layers 15 are alternately disposed so as to face each other with an interval in the third direction D3 in the element body 3. The internal electrode layer 13 and the internal electrode layer 15 have different polarities from each other. One ends of the internal electrode layers 13 and 15 are exposed to the corresponding end surfaces 3e, respectively. The internal electrode layers 13 and 15 include the one ends exposed to the corresponding end surfaces 3e, respectively.

The plurality of internal electrode layers 13 and the plurality of internal electrode layers 15 are alternately arranged in the third direction D3. Each of the internal electrode layers 13 and 15 is located in a plane substantially parallel to the side surface 3a. Each of the internal electrode layers 13 and 15 extends in the first direction D1 and the second direction D2. The internal electrode layer 13 and the internal electrode layer 15 face each other in the third direction D3. The third direction D3 in which the internal electrode layer 13 and the internal electrode layer 15 face each other is orthogonal to the first direction D1 and the second direction D2 parallel to the side surface 3a. A direction parallel to the side surface 3a corresponds to the first direction D1 and the second direction D2.

As illustrated in FIGS. 3 and 4, the plurality of internal electrode layers 13 include one outermost internal electrode layer 13A located outermost in the third direction D3. The outermost internal electrode layer 13A faces one side surface 3a of the pair of side surfaces 3a in the third direction D3. The plurality of internal electrode layers 15 include one outermost internal electrode layer 15A located outermost in the third direction D3. The outermost internal electrode layer 15A faces the other side surface 3a of the pair of side surfaces 3a in the third direction D3.

The plurality of dielectric layers 12 form a pair of outer layer portions 12A and 12B located outside the plurality of internal electrode layers 13 and 15 in the third direction D3 and located so as to sandwich the plurality of internal electrode layers 13 and 15. The pair of outer layer portions 12A and 12B are located outside the outermost internal electrode layers 13A and 15A in the third direction D3. The pair of outer layer portions 12A and 12B are located so as to sandwich the plurality of internal electrode layers 13 and 15 including the outermost internal electrode layers 13A and 15A. The pair of outer layer portions 12A and 12B are located outside all the internal electrode layers 13 and 15 in the third direction D3. The pair of outer layer portions 12A and 12B are located so as to sandwich all the internal electrode layers 13 and 15 in the third direction D3. The thickness of one of the pair of outer layer portions 12A and 12B is a length of 5% to 10% of the entire thickness of the element body 3 in the third direction D3.

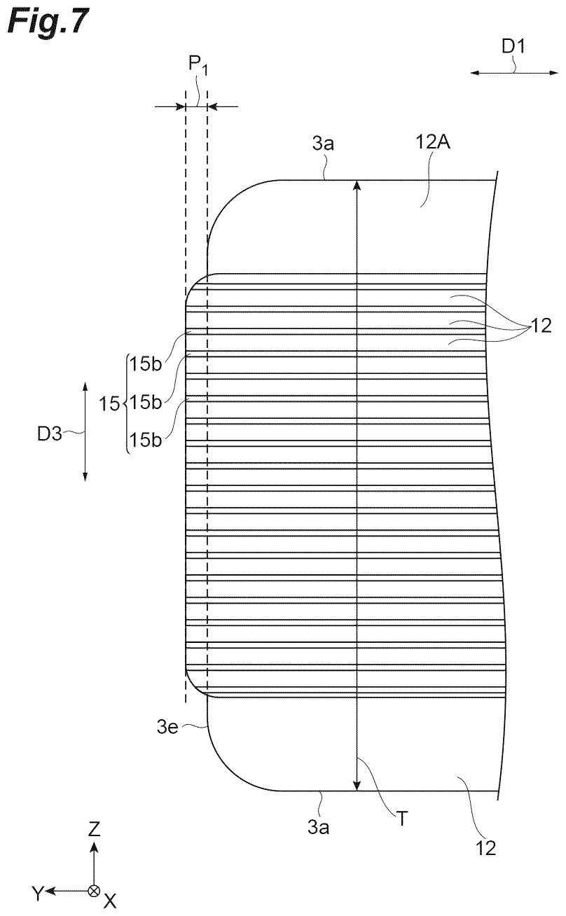

FIG. 7 is an enlarged view of the element body in the extended portion 15b. As illustrated in FIG. 7, the plurality of internal electrode layers 15 protrude from the plurality of dielectric layers 12, respectively. Similarly, the plurality of internal electrode layers 13 also protrude from the plurality of dielectric layers 12, respectively. The extended portions 13b and 15b of the internal electrode layers 13 and 15, respectively, protrude from the plurality of dielectric layers 12 at end surfaces 3e, respectively. The extended portions 13b and 15b of the internal electrode layers 13 and 15, respectively, protrude from the pair of outer layer portions 12A and 12B in the first direction D1 at end surfaces 3e, respectively.

A protrusion length P₁ of the plurality of internal electrode layers 13 and 15 protruding from the pair of outer layer portions 12A and 12B is correlated with the sulfur content in the element body 3. The protrusion length P₁ is a maximum length of the internal electrode layers 13 and 15 protruding from the pair of outer layer portions 12A and 12B in the first direction D1. The protrusion length P₁ depends on a residual amount of sulfur in the element body 3. In the element body 3, the larger the residual amount of sulfur, the larger the protrusion length P₁.

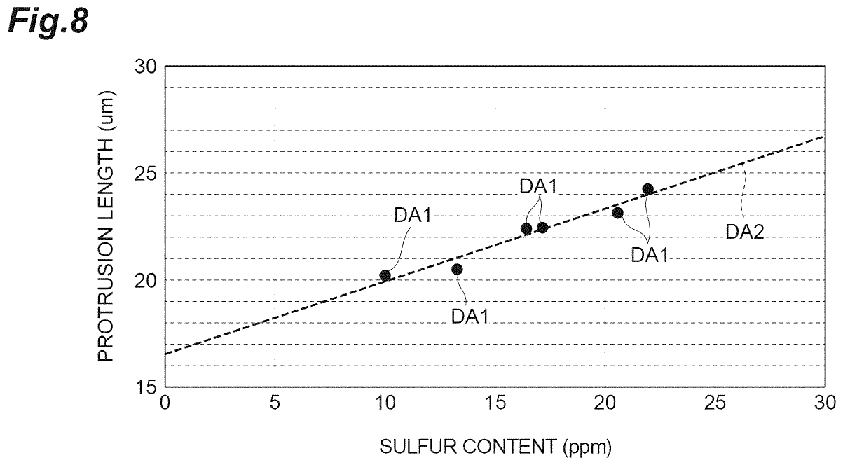

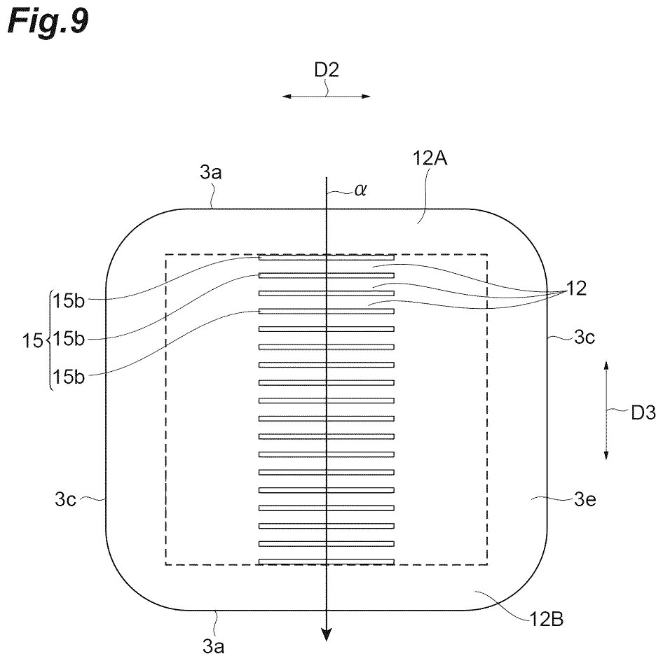

FIG. 8 is a graph showing a relationship between the sulfur content and the protrusion length. In FIG. 8, the data DA1 show plots of measured values of the protrusion length P₁ with respect to the sulfur contents. Datum DA2 is an approximate line of all the data DA1. In the measurement of the protrusion length P₁, as illustrated in FIG. 9, a profile in the first direction D1 is obtained for the end surface 3e of the element body 3 after firing by scanning in the direction of an arrow α. For example, a laser microscope is used to obtain the profile. For example, the maximum length of the internal electrode layer 15 protruding from the pair of outer layer portions 12A and 12B was measured by scanning in the direction of the arrow α, and the maximum length was recorded as the protrusion length P₁. The direction of the arrow a is, for example, the third direction D3.

The multilayer capacitor C1 includes the pair of external electrode terminals 5. The pair of external electrode terminals 5 are disposed on the outer surface of the element body 3. The pair of external electrode terminals 5 are separated from each other. The external electrode terminal 5 may be indirectly disposed on the dielectric layer 12 via an electrical insulating film. The external electrode terminal 5 is disposed on the corresponding end surface 3e side in the element body 3. In the present embodiment, each external electrode terminal 5 is disposed on the pair of side surfaces 3a, the pair of side surfaces 3c, and one end surface 3e.

The external electrode terminal 5 is formed so as to cover five surfaces of the pair of side surfaces 3a, one end surface 3e, and the pair of side surfaces 3c, and the ridge portions 3g, 3i, and 3j. The external electrode terminals 5 are electrically connected to the corresponding internal electrode layers 13 and 15, respectively. The external electrode terminal 5 includes, for example, a plurality of electrode layers. For example, the external electrode terminal 5 includes a first electrode layer and a second electrode layer covering the first electrode layer.

In the example illustrated in FIG. 2, a length B of the external electrode terminal 5 in the first direction D1 is from 0.10 mm to 0.90 mm. A gap G between the pair of external electrode terminals 5 in the first direction D1 is from 0.20 mm to 3.20 mm. For example, the length B of the external electrode terminal 5 in the first direction D1 is 0.70 mm. The gap G between the pair of external electrode terminals 5 in the first direction D1 is 1.95 mm.

In the present embodiment, the first electrode layer includes a sintered metal layer. The sintered metal layer is formed by baking a conductive paste applied to the surface of the element body 3. The sintered metal layer is formed by sintering a metal component (metal powder) contained in the conductive paste. In the present embodiment, the sintered metal layer is made of Cu. The sintered metal layer may be made of Ni. The sintered metal layer contains a base metal. The conductive paste contains, for example, a powder containing Cu or Ni, a glass component, an organic binder, and an organic solvent.

The second electrode layer is formed on the first electrode layer by a plating method. In the present embodiment, the second electrode layer includes a first plating layer and a second plating layer. In the present embodiment, the first plating layer is formed on a conductive resin layer of the first electrode layer by Ni plating. The first plating layer is a Ni plating layer. The first plating layer may be an Sn plating layer, a Cu plating layer, or an Au plating layer. The first plating layer contains Ni, Sn, Cu, or Au. The first plating layer covers a baked metal layer.

The second plating layer is formed on the first plating layer by the plating method. The second plating layer is a solder plating layer. In the example illustrated in the present embodiment, the second plating layer is formed on the first plating layer by Sn plating. The second plating layer is the Sn plating layer. The second plating layer may be an Sn—Ag alloy plating layer, an Sn-Bi alloy plating layer, or an Sn—Cu alloy plating layer. The second plating layer contains Sn, an Sn—Ag alloy, an Sn—Bi alloy, or an Sn—Cu alloy.

Next, effects of the multilayer capacitor C1 described above will be described. In the element body 3 of the multilayer capacitor C1, the weight ratio of the metal containing Ni is from 20% to 25%, and the weight ratio of sulfur is from 3 ppm to 20 ppm. In this case, the occurrence of the cracks in the element body 3 is suppressed, desired electrical characteristics are also secured, and the connection reliability between the external electrode terminal 5 and the internal electrode layers 13 and 15 is improved. Thus, manufacturing throughput can be improved.

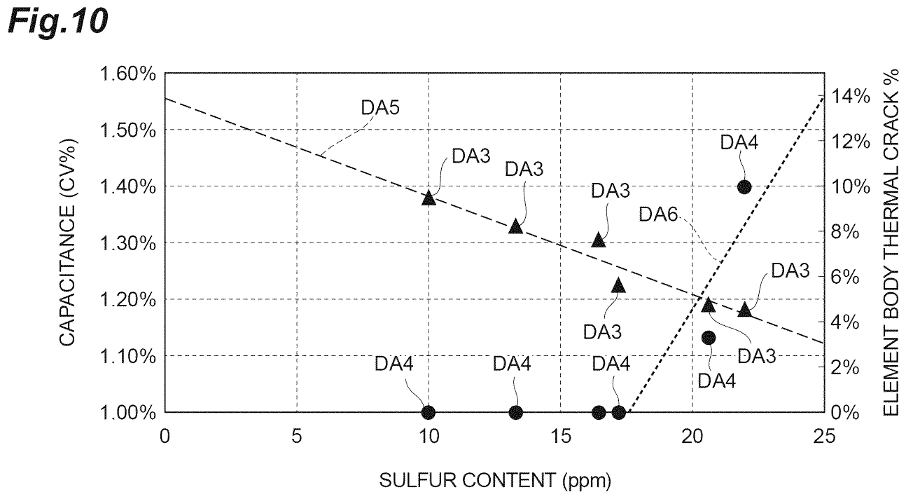

FIG. 10 is a graph showing a relationship among the sulfur content, capacitance, and element thermal cracks. In FIG. 10, data DA3 show plots of the capacitance CV values with respect to the sulfur contents. Data DA4 show plots of occurrence rates of element body thermal cracks with respect to the sulfur contents. Datum DA5 is an approximate line of the data DA3. Datum DA6 is an approximate line of the data DA3.

The data DA3 are CV values calculated from measurement results obtained by measuring the capacitance 30 times for each of a plurality of lots having different sulfur contents. Data DA4 are results of a thermal test. In the thermal test, the element body 3 after firing is immersed in a solder tank at 400° C. for 3 seconds, taken out, and determined whether the cracks occur. The data D4 are the occurrence rates of the cracks in 60 determinations in which the immersion in the solder tank and the determination of the occurrence of the cracks are repeated 60 times.

When the end surface 3e is viewed in plan view along the direction orthogonal to the end surface 3e, the ratio of the area occupied by the plurality of internal electrode layers 13 and 15 to the area of the end surface 3e may be from 5% to 12%. That is, a ratio of an exposed area of each of the extended portions 13b and 15b to the area of the end surface 3e may be from 5% to 12%. In this case, the content ratio of sulfur contained in each of the internal electrode layers 13 and 15 is easily balanced. Thus, the manufacturing throughput can be improved. For example, it is considered that the larger the area of each of the internal electrode layers 13 and 15 exposed from the end surfaces 3e, respectively, the more easily sulfur is removed from the element body 3 in the debinding step.

In each of the plurality of internal electrode layers 13 and 15, when the end surface 3e is viewed in plan view along the direction orthogonal to the end surface 3e, the value obtained by dividing the area of each the internal electrode layers 13 and 15 exposed from the plurality of dielectric layers 12 by the volume of a respective one of the internal electrode layers 13 and 15 may be from 0.15 to 0.40. That is, the ratio of the exposed area of the extended portions 13b and 15b to the volume of the internal electrode layers 13 and 15, respectively, may be from 0.15 to 0.40. In this case, the content ratio of sulfur in the element body 3 is easily balanced. Thus, the manufacturing throughput can be improved. For example, it is considered that the larger the area of each of the internal electrode layers 13 and 15 exposed from the end surfaces 3e, respectively, than the volume of a respective one of the internal electrode layers 13 and 15 containing sulfur, the more sulfur is removed from the element body 3 in the debinding step, and sulfur is less likely to remain in the element body 3.

When the width of the extended portion 15b in the second direction D2 is “W₁” and the width of the overlapping portion 15c in the second direction D2 is “W₂”, 1−(W₁/W₂) may be from 0.35 to 0.55. That is, the drawing ratio may be from 35% to 55%. In this case, the content ratio of sulfur in the element body 3 is easily reduced, and the thickness of the external electrode terminal 5 is easily secured. Thus, the manufacturing throughput can be improved, and infiltration of a liquid into the internal electrode layers 13 and 15 can be suppressed. For example, in a case where the external electrode terminal 5 is formed by dipping into the solder tank, when the width W1 of the extended portion 15b in the second direction D2 is too large, it is difficult to secure the thickness of the external electrode terminal 5.

When viewed along the first direction D1, when a distance WG₁

from the overlapping portions 13c and 15c to an edge of the external electrode terminal 5 in the second direction D2 is too small, a risk that the internal electrode layers 13 and 15 are exposed from the side surface 3c can be reduced. When viewed along the first direction D1, When the width W₁ of the extended portions 13b and 15b in the second direction D2 is too large, a distance WG₂ from the extended portions 13b and 15b to the edge of the external electrode terminal 5 in the second direction D2 decreases, and it is difficult to secure the thickness of the external electrode terminal 5.

The thickness of one of the pair of outer layer portions 12A and 12B may be a length of 5% to 10% of the entire thickness of the element body in the third direction D3. In this case, the content ratio of sulfur in the element body 3 is easily reduced, and the thickness of the external electrode terminal 5 is easily secured. Thus, the manufacturing throughput can be improved, and the infiltration of the liquid into the internal electrode layers 13 and 15 can be suppressed. For example, in the case where the external electrode terminal 5 is formed by dipping into the solder tank, the smaller the thickness of one of the pair of outer layer portions 12A and 12B is, the more the content ratio of sulfur is reduced, but it is difficult to secure the thickness of the external electrode terminal 5.

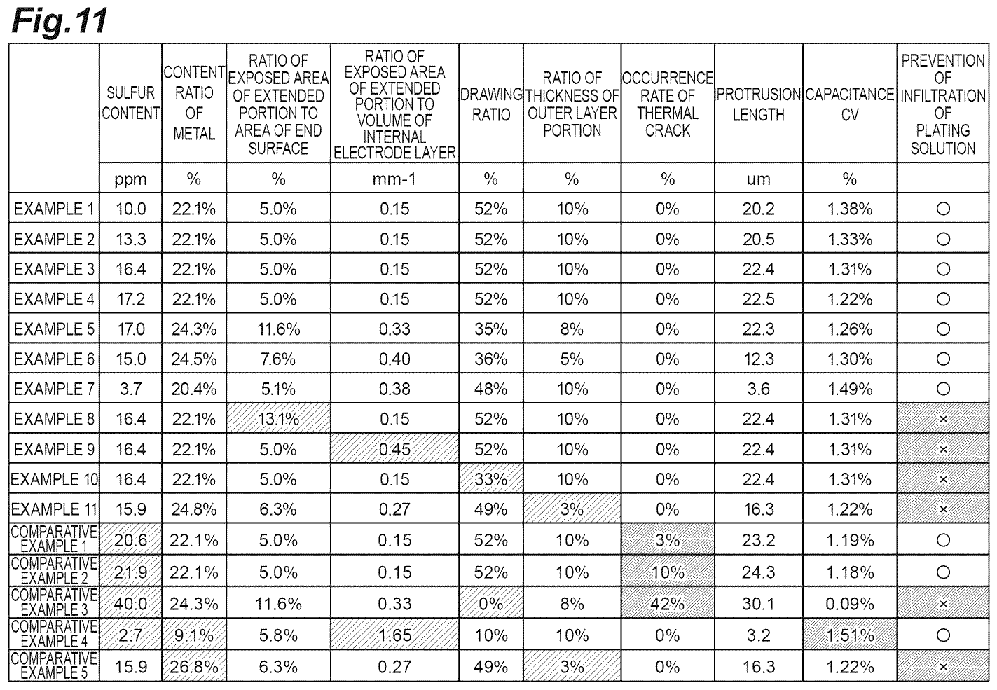

Next, Examples 1 to 12 and Comparative Examples 1 to 5 will be described with reference to FIG. 11. In the multilayer capacitors of Examples 1 to 12, the weight ratio of the metal containing Ni is from 20% to 25%, and the weight ratio of sulfur is from 3 ppm to 20 ppm. In this case, it was confirmed that the thermal cracks occurrence rate in the element body 3 was 0%, the capacitance CV value was from 1.22% to 1.49%, and the protrusion length P₁ was 3.6 μm or more.

In the multilayer capacitors of Examples 1 to 7 and 9 to 12, the ratio of the exposed area of each of the extended portions 13b and 15b to the area of the end surface 3e is 5% to 12%. In this case, it was confirmed that the content ratio of the metal was from 20.4% to 24.8%, and the sulfur content was from 3.7 ppm to 17.2 ppm.

In the multilayer capacitors of Examples 1 to 8 and 10 to 12, the ratio of the exposed area of the extended portions 13b and 15b to the volume of the internal electrode layers 13 and 15, respectively, is from 0.15 to 0.40. In this case, it was confirmed that the content ratio of the metal was from 20.4% to 24.8%, and the sulfur content was from 3.7 ppm to 17.2 ppm.

In the multilayer capacitors of Examples 1 to 9 and 12, the drawing ratio is from 35% to 55%. In this case, it was confirmed that the content ratio of the metal was from 20.4% to 24.8%, and the sulfur content was from 3.7 ppm to 17.2 ppm.

In the multilayer capacitors of Examples 1 to 10, the thickness of each of the outer layer portions 12A and 12B is a length of 5% to 10% of the entire thickness of the element body in the third direction D3. In this case, it was confirmed that the content ratio of the metal was from 20.4% to 24.8%, and the sulfur content was from 3.7 ppm to 17.2 ppm. Further, according to the multilayer capacitors of Examples 1 to 7, it was confirmed that infiltration of a plating solution was also prevented.

Although the embodiments and modification examples of the present invention have been described above, the present invention is not necessarily limited to the above-described embodiments, and various modification examples can be made without departing from the gist thereof.

For example, the configuration of the element body 3 of the multilayer capacitor C1 may be other than the configurations illustrated in Examples 1 to 12. The configuration in which the weight ratio of the metal containing Ni is from 20% to 25% and the weight ratio of sulfur is from 3 ppm to 20 ppm may be controlled by a step other than the debinding step.

As understood from the description of the above-described embodiments, the present specification includes disclosure of the following aspects.

### Supplement 1

A multilayer capacitor including an element body in which a plurality of dielectric layers and a plurality of internal electrode layers extending in a first direction and a second direction orthogonal to each other are alternately laminated in a third direction intersecting the first direction and second direction, and which includes at least one end surface in which at least one internal electrode layer among the plurality of internal electrode layers is exposed from the plurality of dielectric layers, and

an external electrode terminal disposed on the at least one end surface and connected to the at least one internal electrode layer.

In the element body, a weight ratio of a metal containing Ni is from 20% to 25%, and a weight ratio of sulfur is from 3 ppm to 20 ppm.

### Supplement 2

The multilayer capacitor according to Supplement 1, wherein when the end surface is viewed in plan view along a direction orthogonal to the end surface, a ratio of an area occupied by the plurality of internal electrode layers to an area of the end surface is from 5% to 12%.

### Supplement 3

The multilayer capacitor according to Supplement 1 or 2, wherein in each of the plurality of internal electrode layers, when the end surface is viewed in plan view along a direction orthogonal to the end surface, a value obtained by dividing an area of the internal electrode layer exposed from the plurality of dielectric layers by a volume of the internal electrode layer is from 0.15 to 0.40.

### Supplement 4

The multilayer capacitor according to any one of Supplements 1 to 3, wherein the at least one end surface includes a pair of end surfaces at which internal electrode layers different from each other among the plurality of internal electrodes are exposed,

the plurality of internal electrode layers include a pair of internal electrode layers adjacent to each other and exposed at end surfaces different from each other among the pair of end surfaces,

each of the pair of internal electrode layers includes an overlapping portion that overlaps with the overlapping portion of the other internal electrode layer among the pair, and an extended portion connected to the overlapping portion of the same internal electrode layer, extending from the overlapping portion of the same internal electrode layer in the first direction, and exposed at the end surface, and when a width of the extended portion in the second direction is “W₁” and a width of the overlapping portion in the second direction is “W₂”, 1−(W₁/W₂) is from 0.35 to 0.55.

### Supplement 5

The multilayer capacitor according to any one of Supplements 1 to 4, wherein the plurality of dielectric layers form a pair of outer layer portions located outside the plurality of internal electrode layers in the third direction and located so as to sandwich the plurality of internal electrode layers, and

a thickness of one of the pair of outer layer portions is a length of 5% to 10% of the entire thickness of the element body in the third direction.

What is claimed is:

1. A multilayer capacitor comprising:
an element body in which a plurality of dielectric layers and a plurality of internal electrode layers extending in a first direction and a second direction orthogonal to each other are alternately laminated in a third direction intersecting the first direction and second direction, and which includes at least one end surface in which at least one internal electrode layer among the plurality of internal electrode layers is exposed from the plurality of dielectric layers; and
an external electrode terminal disposed on the at least one end surface and connected to the at least one internal electrode layer, wherein
in the element body, a weight ratio of a metal containing Ni is from 20% to 25%, and a weight ratio of sulfur is from 3 ppm to 20 ppm.

2. The multilayer capacitor according to claim 1, wherein
when the end surface is viewed in plan view along a direction orthogonal to the end surface, a ratio of an area occupied by the plurality of internal electrode layers to an area of the end surface is from 5% to 12%.

3. The multilayer capacitor according to claim 1, wherein
in each of the plurality of internal electrode layers, when the end surface is viewed in plan view along a direction orthogonal to the end surface, a value obtained by dividing an area of the internal electrode layer exposed from the plurality of dielectric layers by a volume of the internal electrode layer is from 0.15 to 0.40.

4. The multilayer capacitor according to claim 1, wherein
the at least one end surface includes a pair of end surfaces at which internal electrode layers different from each other among the plurality of internal electrodes are exposed,
the plurality of internal electrode layers include a pair of internal electrode layers adjacent to each other and exposed at end surfaces different from each other among the pair of end surfaces,
each of the pair of internal electrode layers includes an overlapping portion that overlaps with the overlapping portion of the other internal electrode layer among the pair, and an extended portion connected to the overlapping portion of the same internal electrode layer, extending from the overlapping portion of the same internal electrode layer in the first direction, and exposed at the end surface, and
when a width of the extended portion in the second direction is “W₁” and a width of the overlapping portion in the second direction is “W₂”, 1−(W₁/W₂) is from 0.35 to 0.55.

5. The multilayer capacitor according to claim 1, wherein
the plurality of dielectric layers form a pair of outer layer portions located outside the plurality of internal electrode layers in the third direction and located to sandwich the plurality of internal electrode layers, and
a thickness of one of the pair of outer layer portions is a length of 5% to 10% of the entire thickness of the element body in the third direction.
